(19) United States
(12) Patent Application Publication
(10) Pub. No.: US 2026/0177755 A1
(43) Pub. Date: Jun. 25, 2026

(54) OPTICAL CONNECTOR

(71) Applicant: Fujikura Ltd., Tokyo (JP)

(72) Inventor: Ryoichi Mitobe, Sakura-shi (JP)

(73) Assignee: Fujikura Ltd., Tokyo (JP)

(21) Appl. No.: 19/429,338

(22) Filed: Dec. 22, 2025

(30) Foreign Application Priority Data
Dec. 25, 2024 (JP) 2024-228455

(51) Int. Cl. G02B 6/38

(52) U.S. Cl. CPC G02B 6/387; G02B 6/3893

(57) ABSTRACT

An optical connector that connects to an adapter includes a ferrule that has a fiber hole into which an optical fiber is inserted, a housing that accommodates at least a part of the ferrule, an outer coupling that surrounds the housing and slides with respect to the housing, an inner coupling that moves with respect to the outer coupling within a predetermined range, and a biasing unit that biases the inner coupling toward a front side with respect to the outer coupling. The inner coupling moves toward a rear side with respect to the outer coupling by coming into contact with the adapter and then is displaced toward the front side by a biasing force of the biasing unit.

### CROSS-REFERENCE TO RELATED APPLICATION

The present application claims priority to Japanese Patent Application No. 2024-228455, filed Dec. 25, 2024, the content of which is incorporated herein by reference in its entirety.

### BACKGROUND OF THE INVENTION

The present invention relates to an optical connector.

### PATENT LITERATURE

In the related art, a so-called multi-fiber push on (MPO) type optical connector as shown in Japanese Unexamined Patent Application, First Publication No. 2014-13309 has been known. This type of optical connector includes a housing, a coupling, a boot, and the like. The coupling is biased toward a front side by a spring and is slidable with respect to the housing. In a case of inserting the optical connector into an adapter, generally, an operation of gripping and pushing the boot is performed. In this case, the coupling moves toward a rear side once and then moves toward the front side by being pushed by the spring. In this way, the coupling maintains a state in which the adapter and the optical connector are engaged with each other. By pulling the coupling toward the rear side with respect to the housing, a state where the optical connector and the adapter can be disengaged from each other is achieved. In a case of detaching the optical connector from the adapter, an operation of gripping and pulling the coupling is performed.

As described above, in the MPO connector in the related art, a location that is gripped by a user is different between the insertion and the pulling-out of the connector. Therefore, it is difficult to understand the operation, and for example, the boot may be accidentally pulled out during the pulling-out, which may cause damage to the optical connector.

### SUMMARY

The present invention has been made in consideration of such circumstances, and one or more embodiments of the present invention provide an optical connector that can be inserted into and pulled out from an adapter by gripping the same location.

An optical connector according to one or more embodiments of the present invention is an optical connector that is connected to an adapter, and includes a ferrule that has a fiber hole into which an optical fiber is inserted, a housing that accommodates at least a part of the ferrule, an outer coupling that surrounds the housing and is slidable with respect to the housing, an inner coupling that is movable with respect to the outer coupling within a predetermined range, and a biasing unit that biases the inner coupling toward a front side with respect to the outer coupling, in which the inner coupling moves toward a rear side with respect to the outer coupling by coming into contact with the adapter, and then is restored and displaced toward the front side by a biasing force of the biasing unit.

In the optical connector, the inner coupling may have an inner rear locking portion, the outer coupling may have an outer rear locking portion, and the inner rear locking portion may be locked to the outer rear locking portion to restrict the inner coupling from moving toward the front side with respect to the outer coupling beyond a predetermined position.

In the optical connector, the inner coupling and the biasing unit may be separate bodies.

In the optical connector, the inner coupling and the biasing unit may be integrally formed.

According to the above-described embodiments of the present invention, it is possible to provide an optical connector that can be inserted into and pulled out from an adapter by gripping the outer coupling.

### BRIEF DESCRIPTION OF THE DRAWINGS

FIG. 1 is a perspective view of an optical connector in accordance with one or more embodiments.

FIG. 2 is a sectional view taken along a line II-II of FIG. 1.

FIG. 3 is a diagram showing an inner coupling in accordance with one or more embodiments.

FIG. 4 is a perspective view, partly in section, of the optical connector of FIG. 1.

FIGS. 5A and 5B are diagrams showing an operation of the inner coupling.

FIG. 6 is a diagram showing a state where the optical connector is connected to an adapter in accordance with one or more embodiments.

FIG. 7 is a diagram following FIG. 6.

FIG. 8 is a diagram showing an inner coupling in accordance with one or more embodiments.

FIGS. 9A and 9B are diagrams showing an operation of the inner coupling in accordance with one or more embodiments.

### DETAILED DESCRIPTION OF THE INVENTION

Hereinafter, an optical connector is described based on the drawings.

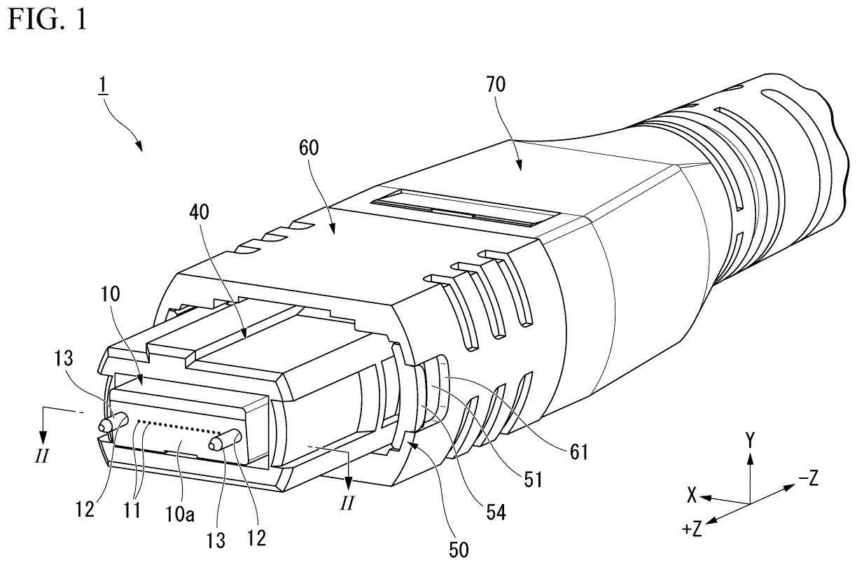

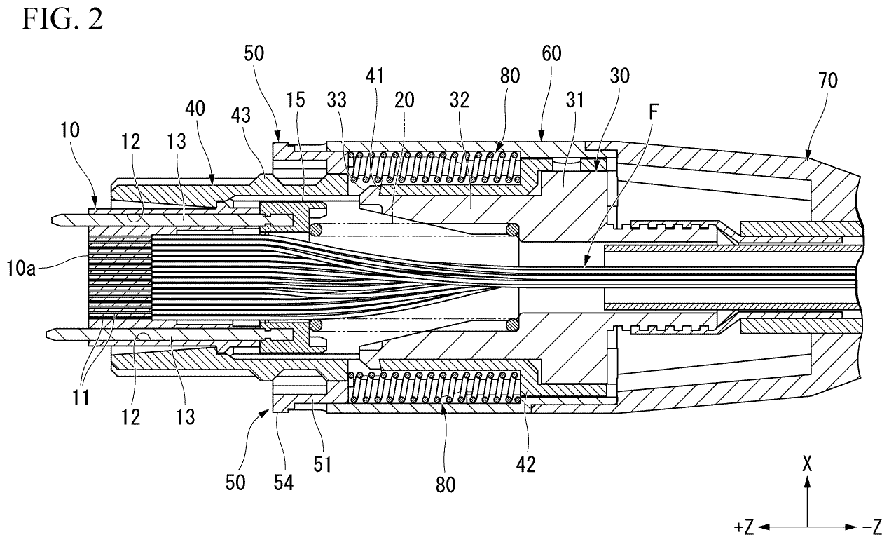

As shown in FIGS. 1 and 2, an optical connector 1 includes a ferrule 10, a ferrule spring 20, a spring push 30, a housing 40, two inner couplings 50, an outer coupling 60, a boot 70, and a plurality of optical fibers F. A plurality of fiber holes 11 arranged in a row are formed in the ferrule 10. In one or more embodiments, 16 fiber holes 11 are arranged in a row. The number of fiber holes 11 may be changed.

The ferrule 10 has a connection end surface 10a. The fiber holes 11 are open on the connection end surface 10a. The optical fiber F is inserted into each of the fiber holes 11. The optical fiber F is exposed on the connection end surface 10a. A connection end surface of another optical connector comes into contact with the connection end surface 10a, so that the optical connector 1 can be optically connected to the other optical connector. However, the optical fibers F do not need to be inserted into some of the fiber holes 11 of the ferrule 10. That is, the number of the optical fibers F may be less than the number of the fiber holes 11.

### (Direction Definition)

A direction in which the plurality of fiber holes 11 extend is referred to as a longitudinal direction Z. The connection end surface 10a side (a +Z side) in the longitudinal direction Z is referred to as a front side. The opposite side thereof (a −Z side) is referred to as a rear side. A direction in which the fiber holes 11 are arranged in a row is referred to as a first direction X. The first direction X is orthogonal to the longitudinal direction Z. A direction orthogonal to both the first direction X and the longitudinal direction Z is referred to as a second direction Y.

Two positioning holes 12 are formed in the ferrule 10. The two positioning holes 12 are disposed to sandwich the plurality of fiber holes 11 therebetween in the first direction X. The optical connector 1 is an optical connector on a male side, and positioning pins 13 are inserted into the positioning holes 12. However, the optical connector 1 may be an optical connector on a female side. That is, the optical connector 1 does not need to have the positioning pin 13.

The optical fiber F is inserted into the fiber hole 11 and extends toward the rear side (in a direction opposite to the connection end surface 10a) from the ferrule 10. The plurality of optical fibers F are inserted into the inside of the ferrule spring 20. The plurality of optical fibers F are also inserted into the inside of the spring push 30 and the inside of the boot 70. The ferrule spring 20 has a function of biasing the ferrule 10 toward the front side. A pin clamp 15 is disposed between the ferrule 10 and the ferrule spring 20.

As shown in FIG. 2, the spring push 30 includes a supporting portion 31 and a pair of engaging claws 32. The pair of engaging claws 32 extend toward the front side from the supporting portion 31. The pair of engaging claws 32 are disposed at an interval in the first direction X. An engaging protrusion 33 that protrudes toward the outside in the first direction X is formed at a tip end of each of the pair of engaging claws 32. The supporting portion 31 supports the ferrule spring 20 from the rear side. The engaging protrusions 33 of the pair of engaging claws 32 are engaged with engaging portions 41 (described later) of the housing 40. With this configuration, the spring push 30 receives a reaction force (a force toward the −Z side) of a biasing force that is generated by the ferrule spring 20 and supports this reaction force.

The housing 40 accommodates a part of the ferrule 10 and the ferrule spring 20 inside thereof. Apart of the ferrule 10 protrudes toward the front side from the housing 40. The ferrule 10 is movable toward the rear side against the biasing force of the ferrule spring 20. Specifically, in a case where the optical connector 1 is connected to another connector, the ferrule 10 is pushed toward the rear side by a ferrule of the other connector. In this way, the ferrule 10 moves toward the rear side with respect to the housing 40.

The shape of the housing 40 is a substantially quadrangular tubular shape. However, the shape of the housing 40 may be changed according to the shape of the ferrule 10 or the like. As shown in FIG. 2, the engaging portion 41 is formed at each of both end portions of the housing 40 in the first direction X. The engaging portion 41 is a hole that penetrates the housing 40 in the first direction X. However, the shape of the engaging portion 41 may be changed as long as the engaging portion 41 can be engaged with the engaging claw 32. In one or more embodiments, the engaging protrusion 33 of the spring push 30 is inserted into the engaging portion 41. By engaging the engaging portion 41 with the engaging claw 32 in this way, the spring push 30 is restricted from falling off from the housing 40.

The outer coupling 60 is disposed to surround the housing 40 from the outside. The outer coupling 60 is slidable in the longitudinal direction Z with respect to the housing 40 within a predetermined range. As shown in FIG. 2, a pair of biasing units 80 are disposed inside the outer coupling 60. The biasing unit 80 is, for example, a compression coil spring. The biasing unit 80 is disposed in a space between the housing 40 and the outer coupling 60 and biases the inner coupling 50 toward the front side (the +Z side). In one or more embodiments, the outer coupling 60 is operated when the optical connector 1 is inserted into or pulled out from an adapter or the like.

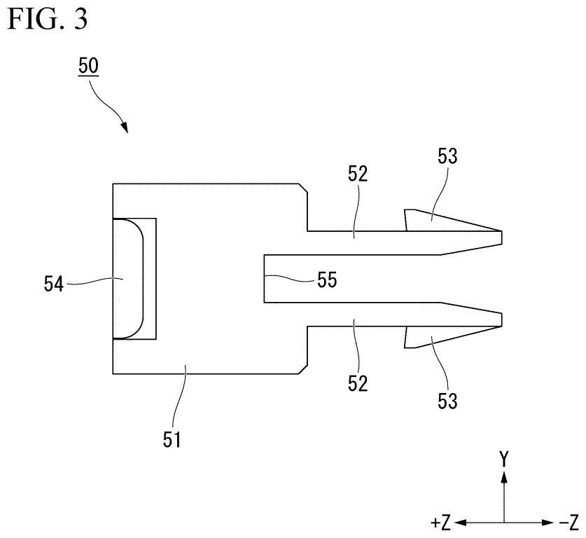

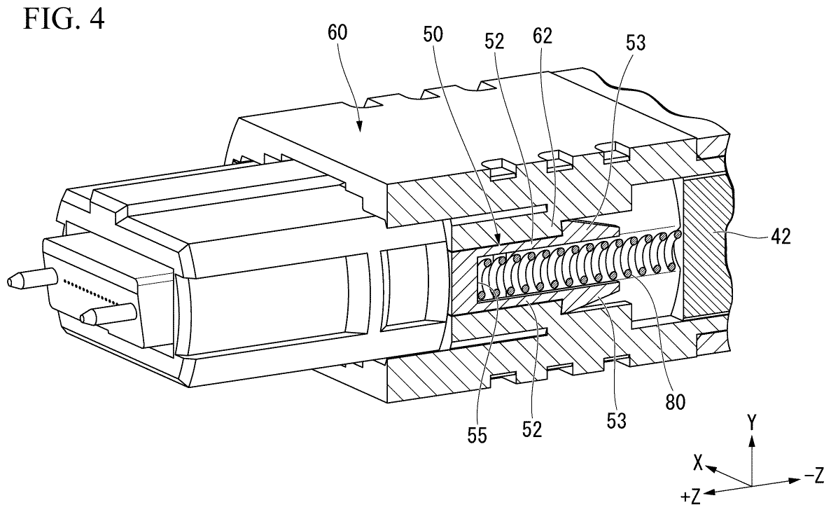

The two inner couplings 50 are disposed at an interval in the first direction X at an end portion of the outer coupling 60 on the front side (the +Z side). Since the two inner couplings 50 have the same shape and function, only one inner coupling 50 will be described below. As shown in FIG. 3, the inner coupling 50 includes a main body portion 51, two locking pieces 52, two inner rear locking portions 53, an inner front locking portion 54, and a contact portion 55. The two locking pieces 52 extend toward the rear side (the −Z side) from the main body portion 51 and are provided at an interval in the second direction Y Each of the two inner rear locking portions 53 protrudes toward the outside in the second direction Y from each of the two locking pieces 52. The two inner rear locking portions 53 are locked to an outer rear locking portion 62 (refer to FIG. 4) formed inside the outer coupling 60. The inner front locking portion 54 protrudes toward the outside in the first direction X from the main body portion 51 (refer to FIG. 1). An outer front locking portion 61 is formed at each of both end portions of the outer coupling 60 in the first direction X. The outer front locking portion 61 is a recessed portion that is recessed from the end portion of the outer coupling 60 on the front side toward the rear side. The inner front locking portion 54 is disposed inside the outer front locking portion 61.

The contact portion 55 is a surface of the main body portion 51, which faces the rear side (the −Z side). As shown in FIG. 4, the biasing unit 80 is in contact with the contact portion 55. In addition, the biasing unit 80 is compressed between the contact portion 55 and a spring supporting portion 42 of the housing 40. In this way, the inner coupling 50 receives a forward biasing force by the biasing unit 80. Since the inner rear locking portions 53 are locked to the outer rear locking portion 62, the forward biasing force by the biasing unit 80 is also transmitted to the outer coupling 60 via the inner coupling 50. That is, the outer coupling 60 is also biased toward the front side by the biasing unit 80. In addition, the inner rear locking portions 53 are locked to the outer rear locking portion 62, so that the movement of the inner coupling 50 toward the front side beyond a predetermined position with respect to the outer coupling 60 is restricted. In other words, the inner coupling 50 is restricted from falling off from the outer coupling 60 by the biasing force of the biasing unit 80.

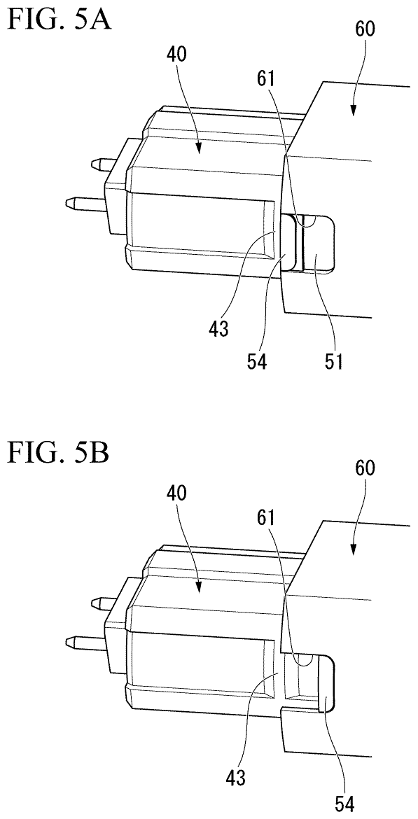

With the above-described configuration, the inner coupling 50 is slidable in the longitudinal direction Z with respect to the outer coupling 60 within a predetermined range. FIG. 5A shows a state in which the inner coupling 50 is located on the most front side with respect to the outer coupling 60. FIG. 5B shows a state in which the inner coupling 50 is located on the most rear side with respect to the outer coupling 60. In a case where no external force is applied, the optical connector 1 is in a state shown in FIG. 5A. In a case where an external force toward the rear side is applied to the inner coupling 50, the optical connector 1 is in a state shown in FIG. 5B.

In the state shown in FIG. 5A, the inner coupling 50 partially covers a protrusion portion 43 formed on the side surface of the housing 40. As shown in FIG. 5B, in a case where the inner coupling 50 slides toward the rear side, the entire protrusion portion 43 is exposed. In addition, in this case, the inner front locking portion 54 is locked to the outer front locking portion 61. In this way, the movement of the inner coupling 50 toward the rear side beyond a predetermined position with respect to the outer coupling 60 is restricted.

Next, an operation of the optical connector 1 configured as described above will be described.

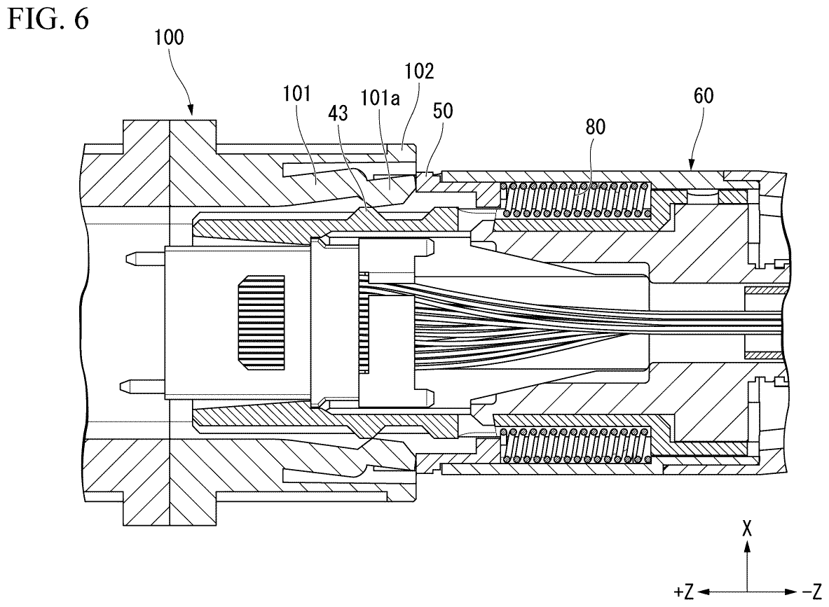

The optical connector 1 is used in combination with, for example, an adapter 100 shown in FIG. 6. Although not shown in the drawing, another connector to be connected to the optical connector 1 is inserted into the adapter 100 from the +Z side. The adapter 100 has a function of maintaining a state in which the other connector and the optical connector 1 are connected to each other. The adapter 100 includes two locking claws 101 and a peripheral wall 102. The two locking claws 101 are formed inside the peripheral wall 102. A gap is provided between the locking claw 101 and the peripheral wall 102. In addition, a locking protrusion 101a is formed on the locking claw 101.

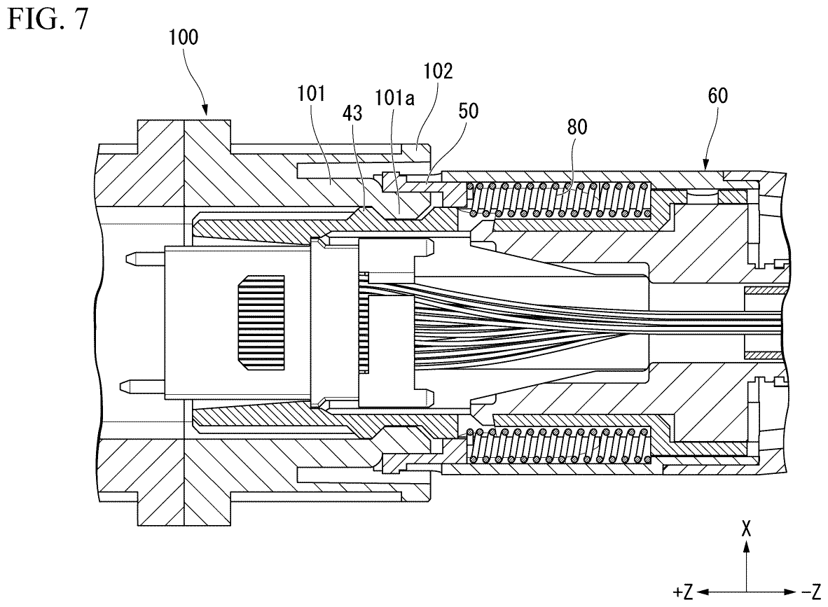

When inserting the optical connector 1 into the adapter 100, the user grips the outer coupling 60 and pushes the optical connector 1 toward the adapter 100. At this time, as shown in FIG. 6, the inner coupling 50 comes into contact with a tip end portion (an end portion on the −Z side) of the locking claw 101. The inner coupling 50 slides toward the rear side against the forward biasing force by the biasing unit 80. At this time, elastic energy is accumulated in the biasing unit 80. Further, at the same time, the locking protrusion 101a comes into contact with an inclined surface of the protrusion portion 43, whereby the locking claw 101 is elastically deformed toward the outside in the first direction X. When the optical connector 1 is further pushed in, the protrusion portion 43 climbs over the locking protrusion 101a toward the front side (the +Z side) to be in a state shown in FIG. 7.

As shown in FIG. 7, when the elastic deformation of the locking claw 101 is released, a gap is generated between the locking claw 101 and the peripheral wall 102. The inner coupling 50 is advanced by the released elastic energy of the biasing unit 80 and a part of the inner coupling 50 is inserted into the gap. Since the part of the inner coupling 50 is inserted between the locking claw 101 and the peripheral wall 102, the locking claw 101 is restricted from being elastically deformed by an external force. Accordingly, it is possible to maintain a state where the adapter 100 and the optical connector 1 are connected to each other.

In a case of releasing the connection between the adapter 100 and the optical connector 1, the user grips the outer coupling 60 and pulls the outer coupling 60 toward the rear side (the −Z side). At this time, as shown in FIG. 4, an operation force toward the rear side is transmitted from the outer rear locking portion 62 of the outer coupling 60 to the inner rear locking portions 53 of the inner coupling 50. Therefore, the outer coupling 60 and the inner coupling 50 slide together toward the rear side with respect to the housing 40.

The inner coupling 50 moves toward the rear side, so that the inner coupling 50 is separated from the gap between the locking claw 101 and the peripheral wall 102. In this way, a state where the locking claw 101 is elastically deformable is created again. When the outer coupling 60 moves toward the rear side by a predetermined amount with respect to the housing 40, a state where the operation force toward the rear side is also transmitted to the housing 40 is created. Due to this operation force, the locking protrusion 101a is pushed against the inclined surface of the protrusion portion 43, and the locking claw 101 is elastically deformed toward the outside in the first direction X. When the user further pulls the optical connector 1 toward the rear side, the protrusion portion 43 climbs over the locking protrusion 101a toward the rear side, and the connection between the adapter 100 and the optical connector 1 is released.

As described above, the optical connector 1 is connected to the adapter 100 in accordance with one or more embodiments. The optical connector 1 includes the ferrule 10 that has the fiber hole 11 into which the optical fiber F is inserted, the housing 40 that accommodates at least a part of the ferrule 10, the outer coupling 60 that surrounds the housing 40 and is slidable with respect to the housing 40, the inner coupling 50 that is movable with respect to the outer coupling 60 within a predetermined range, and the biasing unit 80 that biases the inner coupling 50 toward the front side with respect to the outer coupling 60. The inner coupling 50 moves toward the rear side with respect to the outer coupling 60 by coming into contact with the adapter 100, and then is restored and displaced toward the front side by the biasing force of the biasing unit 80.

According to the optical connector 1, the optical connector 1 can be inserted into and pulled out from the adapter 100 by gripping the outer coupling 60. Since the insertion and the pulling-out of the connector 1 can be performed by gripping the same location in this manner, it is possible to prevent an erroneous operation.

In addition, the inner coupling 50 includes the inner rear locking portion 53, and the outer coupling 60 includes the outer rear locking portion 62. The inner rear locking portion 53 is locked to the outer rear locking portion 62 to restrict the inner coupling 50 from moving toward the front side with respect to the outer coupling 60 beyond a predetermined position. According to this configuration, the inner coupling 50 biased toward the front side by the biasing unit 80 is prevented from falling off from the outer coupling 60.

In addition, the inner coupling 50 and the biasing unit 80 are separate bodies. The biasing unit 80 is a compression coil spring, and the biasing unit 80 is compressed between the inner coupling 50 and the housing 40.

Hereinafter, an optical connector is further described based on the drawings. The basic configuration thereof is the same as hereinabove. Therefore, the same configurations will be denoted by the same reference numerals, the description thereof will be omitted, and only the different points will be described.

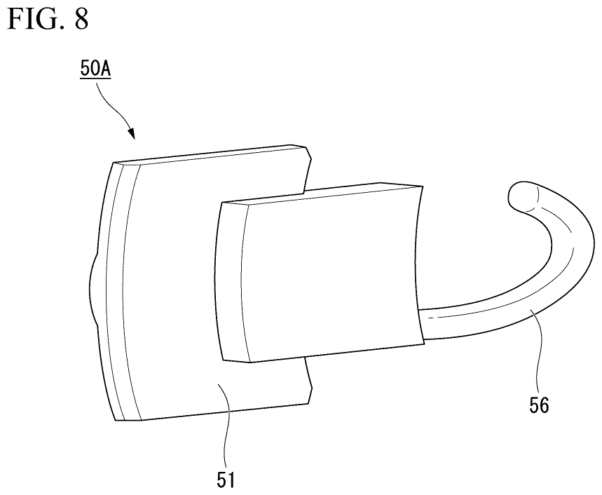

The inner coupling 50 is a separate body from the biasing unit 80. The optical connector 1 includes an inner coupling 50A shown in FIG. 8, instead of the inner coupling 50 and the biasing unit 80 described hereinabove. The inner coupling 50A includes a biasing unit 56 in addition to the main body portion 51 that is the same as described hereinabove. That is, the inner coupling 50A and the biasing unit 56 are integrally molded. The biasing unit 56 has a J-shaped hook shape. The biasing unit 56 is formed of a resin having elasticity.

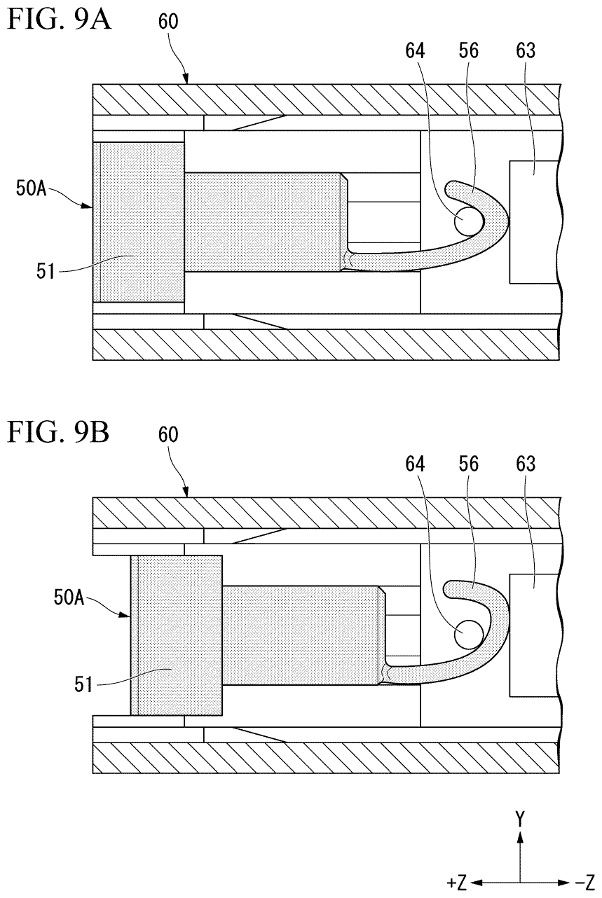

FIGS. 9A and 9B are diagrams showing an operation of the inner coupling 50A, and are drawings corresponding to FIGS. 5A and 5B. FIGS. 9A and 9B are sectional views partially showing a space inside the outer coupling 60 by breaking a part of the outer coupling 60. As shown in FIG. 9A, a spring receiving portion 63 and a spring hooking portion 64 are formed inside the outer coupling 60.

The spring receiving portion 63 and the spring hooking portion 64 are disposed side by side in the longitudinal direction Z. The spring receiving portion 63 is located on the rear side (the −Z side) with respect to the biasing unit 56, and the spring hooking portion 64 is located on the front side (the +Z side) with respect to the biasing unit 56. Although not shown in the drawing, the spring receiving portion 63 and the spring hooking portion 64 protrude toward the inside in the first direction X from an inner surface (a surface facing the first direction X) of the outer coupling 60. The spring hooking portion 64 is located inside the hook-shaped biasing unit 56. FIG. 9A shows a state in which an external force is not applied to the inner coupling 50A.

The inner coupling 50A operates in the same manner as described hereinabove. That is, when the optical connector 1 is inserted into the adapter 100, the inner coupling 50A is pushed toward the rear side by the adapter 100 (refer to FIGS. 6 and 9B). When an external force toward the rear side is applied to the inner coupling 50A, the biasing unit 56 is pressed against the spring receiving portion 63 and is elastically deformed as shown in FIG. 9B. At this time, elastic energy is accumulated in the biasing unit 56. When the elastic deformation of the locking claw 101 is released (refer to FIG. 7), a gap is generated between the locking claw 101 and the peripheral wall 102. The inner coupling 50A is advanced by the released elastic energy of the biasing unit 56 and a part of the inner coupling 50A is inserted into the gap. Since the part of the inner coupling 50A is inserted between the locking claw 101 and the peripheral wall 102, the locking claw 101 is restricted from being elastically deformed by an external force. Accordingly, it is possible to maintain a state where the adapter 100 and the optical connector 1 are connected to each other.

As described above, the optical connector 1 includes the ferrule 10 that has the fiber hole 11 into which the optical fiber F is inserted, the housing 40 that accommodates at least a part of the ferrule 10, the outer coupling 60 that surrounds the housing 40 and is slidable with respect to the housing 40, the inner coupling 50A that is movable with respect to the outer coupling 60 within a predetermined range, and the biasing unit 56 that biases the inner coupling 50A toward the front side with respect to the outer coupling 60. The inner coupling 50A moves toward the rear side with respect to the outer coupling 60 by coming into contact with the adapter, and then is restored and displaced toward the front side by the biasing force of the biasing unit 56.

In addition, the inner coupling 50A and the biasing unit 56 are formed integrally. Therefore, the number of components can be reduced. In addition, the biasing unit is prevented from being separated from the inner coupling to be lost when assembling the optical connector 1.

In addition, the technical scope of the present invention is not limited to the above-described embodiments, and various modifications can be made within a scope which does not depart from the gist of the present invention.

For example, the shape of the biasing unit 56 may be changed and may be a U shape or the like.

In addition, it is possible to appropriately replace the components in the embodiments described above with well-known components within a scope which does not depart from the gist of the present invention, and the embodiments or modification examples described above may be combined appropriately.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An optical connector that connects to an adapter, the optical connector comprising:
a ferrule that has a fiber hole into which an optical fiber is inserted;
a housing that accommodates at least a part of the ferrule;
an outer coupling that surrounds the housing and slides with respect to the housing;
an inner coupling that moves with respect to the outer coupling within a predetermined range; and
a biasing unit that biases the inner coupling toward a front side with respect to the outer coupling,
wherein the inner coupling moves toward a rear side with respect to the outer coupling by coming into contact with the adapter, and then is displaced toward the front side by a biasing force of the biasing unit.

2. The optical connector according to claim 1, wherein
the inner coupling has an inner rear locking portion,
the outer coupling has an outer rear locking portion, and
the inner rear locking portion is configured to lock with the outer rear locking portion and to restrict the inner coupling from moving toward the front side with respect to the outer coupling beyond a predetermined position.

3. The optical connector according to claim 1, wherein the inner coupling and the biasing unit are separate bodies.

4. The optical connector according to claim 1, wherein the inner coupling and the biasing unit are integrally formed.

5. The optical connector according to claim 1, wherein the inner coupling contacts with a tip end portion of a locking claw of the adapter.

6. The optical connector according to claim 5, wherein a locking protrusion of the locking claw contacts with a protrusion portion of the housing.
